(19) United States
(12) Patent Application Publication
(10) Pub. No.: US 2006/0178166 A1
(43) Pub. Date: Aug. 10, 2006

(54) Configurable integrated circuit card

(75) Inventors: Lu Vinh Luu, Tustin, CA (US); Daniel V. H. Luu, Houston, TX (US)

Correspondence Address: ST. ONGE STEWARD JOHNSTON & REENS, LLC, 986 BEDFORD STREET, STAMFORD, CT, 06905-5619, US

(73) Assignee: Pacusma Company Limited

(21) Appl. No.: 11/054,397

(22) Filed: Feb. 9, 2005

(51) Int. Cl. H04M 1/00

(52) U.S. Cl. 455/558; 455/556.1

(57) ABSTRACT

A configurable electronic information storage card for use with portable electronic equipment, such as a mobile phone, the card being provided with at least one integrated electronic module chip including a memory for saving a plurality of data formats to enable the electronic device to connect to a local network and perform at least one device application, the system being supplied with a data format selector for selecting a data format compatible with the local network.

### FIELD OF THE INVENTION

The present invention relates to a data storage unit for use in portable electronic devices, and more specifically to a configurable electronic information storage card.

### BACKGROUND OF THE INVENTION

Memory identification cards are currently known and used in connection with many types of electronic devices, especially communication devices such as mobile telephones, for storing data, enabling secure access to a particular network or account, or configuring such devices to perform different functions. These cards typically have a semiconductor chip module mounted or embedded thereon, the chip module including a memory and having contact or connection points for electrically connecting the terminals of the integrated circuit to a contact interface in the electronic device in which the card is inserted. Traditionally, portable information or memory cards must be provided with standardized dimensions with the chip oriented in a predetermined position relative to the edges of the card, depending on the type of electronic device.

Such cards have been widely utilized in connection with for instance, Global Services for Mobile (GSM) telephones including Subscriber Identity Modules (SIM) cards to identify a user and enable the user to access the wireless telephone network in a particular country. Each SIM module may contain the particular configuration information for a specific network, and also may contain information identifying the user, such as for instance, the user's mobile telephone number. It should be noted however, that often the case is that the mobile telephone networks from country to country or territory to territory differ in format and configuration and therefore require use of a SIM module compatible with the particular country or territory network. In places where travel between countries or territories is common, the user must therefore have mulitiple SIM cards to operate their phone. Typically a pre-paid monetary value may be associated with a particular SIM card to allow the user to access a local network up to the pre-paid value.

One invention that has sought to address these problems is U.S. Pat. No. 6,641,049 to Luu (“the '049 patent”). The '049 patent teaches a system in which multiple Integrated Circuits (IC) are positioned on a card, each IC having a data format designed to be compatible with a particular network. In this way, a user may have their SIM card inserted in their phone in one orientation for a particular country, but when they move into a different territory or country with a different network, the user may simply remove the SIM card, re-orient the card and re-insert it so that the correct circuitry is connected to the device for the current network. However, one drawback of the '049 patent is that the number of different network configurations that may be placed on the SIM card is limited by the physical space on the SIM card and by the physical insertion positioning of the card. In Europe and Asia, many different network systems are utilized each requiring a particular network format for the SIM card and therefore a number of different SIM cards may be required.

Other types of electronic cards currently known in the art include MultiMedia cards (MMCs), secure digital (SD) memory cards, SmartMedia™ cards, and Sony Memory Stick™.

MMCs are data storage mediums having a relatively compact size and relatively high storage capacity, and are commonly provided to be connectable to a portable communication device. MMCs are similar to flash memory and ROM, but are removable and exchangeable, thus providing greater flexibility and capabilities to portable smart phones, cellular telephones, and pagers, etc.

SD memory cards are typically used in conjunction with palmtop computers, personal computers, digital cameras, audio/voice recorders, printers, and game consoles. Like SIM cards and MMCs, SD memory cards are non-volatile, meaning they do not require power to retain the information stored therein. They are also solid state devices, so they have no moving parts to wear out. SD memory cards typically enable high-speed, user-friendly, and secure downloading of digital files. Files can be easily transferred from a PC to the SD memory card, or vice versa, whereupon the SD card containing the transferred information can then be used in another electronic device.

As with the SIM cards, if a user desires to perform more than one function or capability with the device or requires more storage than available on one of the MMC or SD memory card, it will be necessary for the user to carry and switch between two or more cards, which is, of course, inconvenient.

What is desired then is a multi-format SIM card that is compatible with different country or territory networks.

It is further desired to provide a system and method for providing a configurable SIM card such that a format may be selected that is compatible with the local network.

### SUMMARY OF THE INVENTION

The present invention overcomes the disadvantage encountered in the prior art discussed above by providing an integrated circuit card an integrated electronic module that is configurable such that a configuration may be selected that is compatible with the local network, thus eliminating the need to carry an additional card for each additional function or application.

The present invention may, in one advantageous embodiment, include a memory that comprises a plurality of network data formats such that when a user enters a territory, they may scroll through a list of country or territories and select the configuration for the local network. The need for carrying a different card for each integrated electronic module is therefore eliminated.

In a one embodiment of the invention, an integrated circuit card is provided that is insertable into and electronic device to facilitate communication with a network. The integrated circuit card comprises a card that is keyed for insertion in a particular orientation into the electronic device. The integrated circuit card further comprises at least one integrated electronic module mounted to the card. Also included is a storage located on the card and is assessable by the at least one integrated electronic module. The storage includes a plurality of data formats, where each data format corresponds to a different network for the electronic device to communicate with. Still further, the integrated circuit card comprises a selector, which may be used to select one of the plurality of data formats located on the storage. The at least one integrated electronic module then enables the electronic device to perform an electronic device application when the at least one integrated electronic module is configured with a selected data format compatible with the network.

In one advantageous embodiment, the integrated electronic module and the storage may be provided for instance, as one semiconductor chip located on the integrated circuit card.

In another advantageous embodiment the selector may include a visual display and interface so that a user may select one of the plurality of data formats. The visual display may in one application, include a display located on a mobile phone and the interface may include an alpha-numeric keypad located on the phone. In this advantageous embodiment, it may be further advantageous to present the plurality of data formats to the user on the visual display in the form of a list, for instance corresponding to a number of different countries or territories. In this manner the user may select the country or territory on the list that corresponds to the data format for that country or territory.

In another advantageous embodiment, a method of providing a data format for an integrated circuit module located on a SIM card for use with a mobile phone to facilitate communication of the mobile phone with a local network is provided comprising the steps of, locating at least one integrated electronic module on the SIM card, providing a storage accessible by the integrated electronic module, and storing a plurality of data formats on the storage, each data format corresponding to a different network. The method further comprises the steps of accessing the plurality of data formats saved on the storage, selecting one of the plurality of data formats, and performing an electronic device application when the at least one integrated electronic module is configured with the selected data format that is compatible with the network.

It is further contemplated that it may be advantageous to provide for updating of the plurality of data formats saved on the storage. It may also be advantageous to provide for adding of additional data formats to the storage, all of which may be added to the list of countries or territories the user may select from.

The enumerated advantageous features of the present invention then eliminate the need for the user to in one application, carry numerous SIM cards when moving from country to country or even to remove and flip the existing SIM card in the mobile phone. Rather, the user simply selects the country or territory on a list corresponding to the local network which is then loaded for use by the integrated circuit module.

Other features and advantages of the present invention will become apparent from the following description of the invention which refers to the accompanying drawings.

### BRIEF DESCRIPTION OF THE DRAWINGS

FIG. 1 is a block diagram of one advantageous embodiment of the present invention illustrating the interconnection of the integrated circuit card with the electronic device.

FIG. 2 is a block diagram according to FIG. showing an alternative embodiment of the integrated circuit card.

FIG. 3 is a block diagram according to FIG. 1 showing the selector in greater detail.

FIG. 4 is an illustration of the advantageous embodiment according to FIG. 1 showing a front surface view of a full ISO sized integrated electronic card having the shape of a plug-in sized card die cut therein, with the integrated electronic module mounted inside a die-cut plug-in card region.

### DETAILED DESCRIPTION OF THE DRAWINGS

It should be noted that the integrated circuit card of the present invention may be for instance, a modification of a SIM card, either the full-ISO size or the plug-in/micro size; a MultiMedia card (MMC); a secure digital (SD) memory card; or any other type of flash, non-volatile, solid state memory card or integrated electronic module card as previously described herein.

Integrated electronic cards are typically made of plastic and have an electronic chip module mounted or embedded therein. The module is a semiconductor chip including an integrated circuit with memory, and contact or connection terminals for electrically connecting the terminals of the integrated circuit to the contact interface in the electronic device into which the card is inserted. Portable integrated electronic cards are typically provided with standardized dimensions with the chip positioned in a predetermined location relative to the edges of the card, depending on the type of electronic device. For instance, SIM cards may be provided in a full-ISO size or a micro/plug-in size. To ensure correct orientation of the SIM card upon insertion in the mobile phone, one corner of the otherwise rectangular card may be keyed, which may include cutting it at an angle. The card may then only be inserted in the phone with an angled corner in a correct orientation.

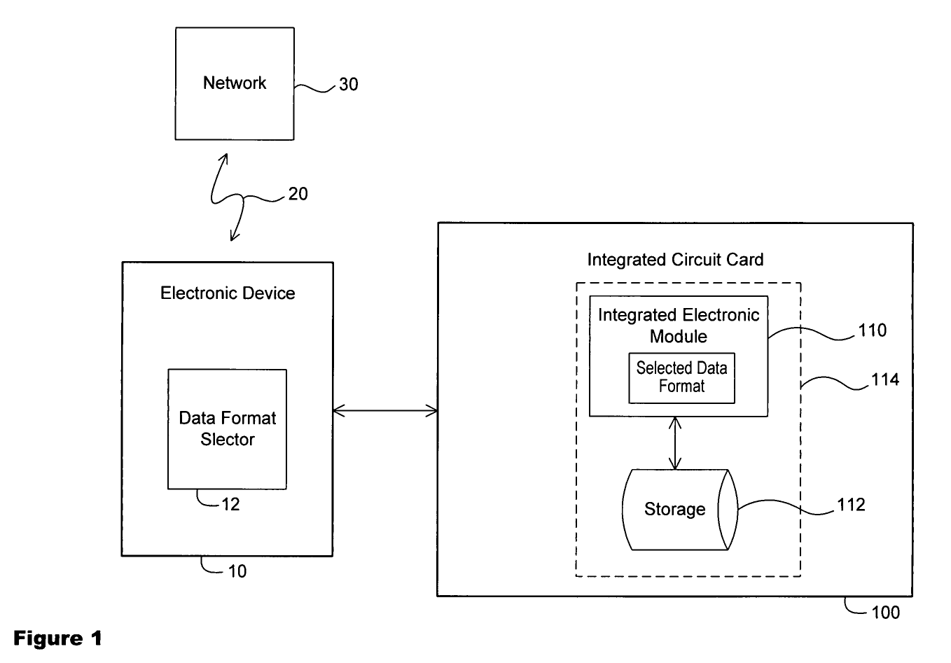

FIG. 1 is a block diagram illustrating one advantageous embodiment of the present invention. FIG. 1 includes electronic device 10, which may comprise for instance but is not limited to a mobile or cellular telephones (such as a GSM telephone), portable or handheld computers, or any other type of electronic device or appliance compatible with portable memory.

Electronic device 10 is adapted to receive integrated circuit card 100 therein and is coupled to integrated circuit card 100 as is known in the art and may comprise for instance, a SIM card. The SIM card produced in accordance with the present invention may be provided as either a full-size ISO card or as a plug-in sized card. The full-sized card may have the shape of the plug-in sized card die cut therein, so that the smaller card size can be easily detached from the larger card body to be used as a plug-in sized card.

The integrated circuit card 100 is provided with an integrated electronic module 110 located thereon and is coupled to storage 112 also located on integrated circuit card 100. Integrated electronic module 110 and storage 112 may in one advantageous embodiment be provided in one integrated electronic module chip 114 as indicated in FIG. 1 by a dashed line.

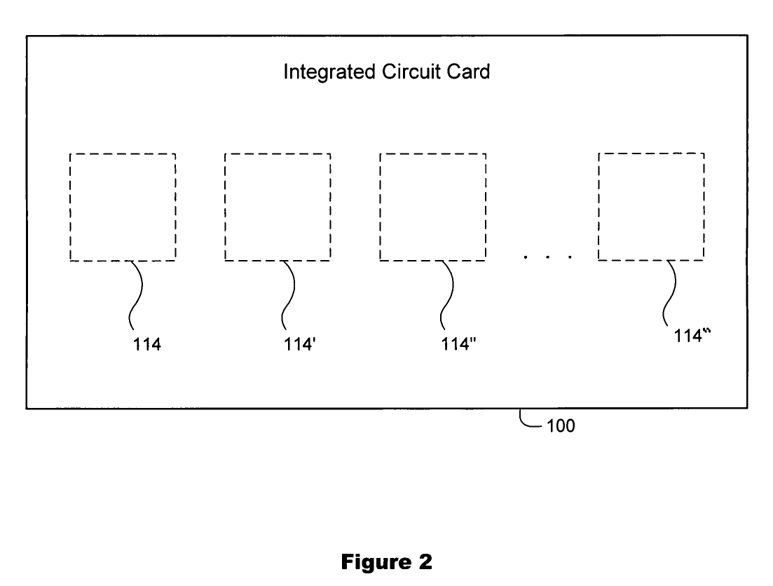

The integrated electronic module chip 114 may comprise any size or shape as long as the contact or connection points of the integrated electronic module 112 are positioned to contact connection terminals (not shown) in electronic device 10 when the integrated circuit card 10 is inserted therein. It should be noted that while only one integrated electronic module chip 114 is illustrated as located on integrated circuit card 100 in FIG. 1, any number of integrated electronic module chips 114′, 114″, . . . 114ⁿ (FIG. 2) may effectively be utilized. In the case where additional integrated electronic module chips 114′, 114″, . . . 114ⁿ are utilized, integrated circuit card 100 may then be keyed in a manner to facilitate connection of the various integrated electronic module chips 114′, 114″, . . . 114ⁿ with the contact connection terminals (not shown) in electronic device 10.

Storage 112 may comprise any type of non-volatile electronic memory accessible by integrated electronic module 110. It should further be noted that while storage 112 is illustrated as a single unit, it may comprise any number of memory units adapted to store data corresponding to various data formats for differing network systems. It is still further contemplated that storage 112 may comprise a Read Only Memory (ROM) or may comprise a read-write memory that may be updated and/or reconfigured.

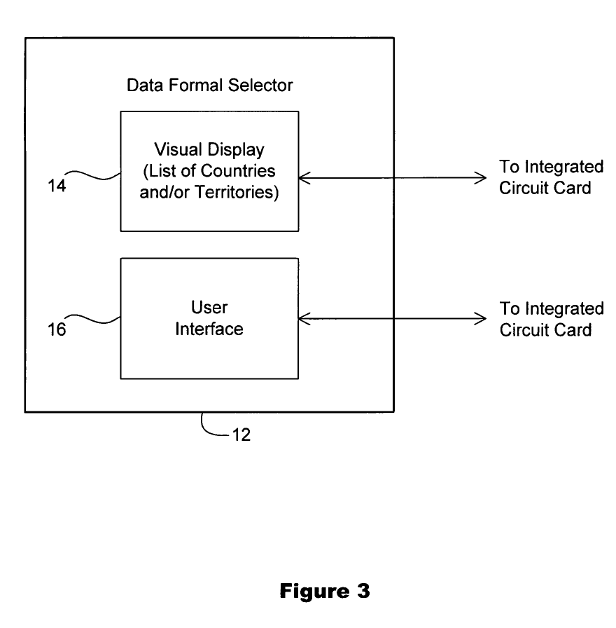

Electronic device 10 is provided with data format selector 12, which is illustrated in more detail in FIG. 3. Data format selector 12 may further comprise a visual display 14 and a user interface 16. Once the integrated circuit card 100 is inserted into electronic device 10, then a user may, via the data format selector, access storage device 112 to select the desired data format for integrated electronic module 110. The information saved in storage 112 may be presented to the user via visual display 14 in the form of for instance, a list, which the user may cycle through in order to select the desired data format. The list may comprise a country and/or territory listing such that the user need only select the country or territory to load the data format compatible with that country or territory network. It is contemplated that any number of country and/or territory files may be saved in storage 112, which may or may not be edited.

The user interface may comprise any interface that will allow the user to access the information saved in storage 112. For instance, the user interface 16 may in one advantageous embodiment comprise an alpha-numeric keypad such as is typically used in connection with a phone. Alternatively, the user interface 16 may comprise a selector switch or directional key(s) that allows the user to scroll through different options on visual display 14.

Also depicted in FIG. 1 is communications link 20 which couples electronic device 10 with network 30. Communications link 20 may comprise or include any one or more of the following but is not limited to: a WAP (Wireless Application Protocol) link, a GPRS (General Packet Radio Service) link, a GSM (Global Services for Mobile) communication link, or other wired or wireless, digital or analog interfaces or connections.

While data format selector 12 has been described in one advantageous embodiment as a selection system that may be manually operated by a user, it is contemplated that data format selector 12 may automatically select the correct data format from storage 112 upon establishing communication with network 30 via communications link 20. It is still further contemplated that a combination of manual and automatic selection features may be employed for selection of a compatable data format. For instance, the electronic device 10 may prompt the user to insert an integrated circuit card 100 into electronic device 10, once the user indicates the integrated circuit card 100 or upon insertion of the integrated circuit card 100, the electronic device 10 may then automatically select a compatible data format saved on storage 112.

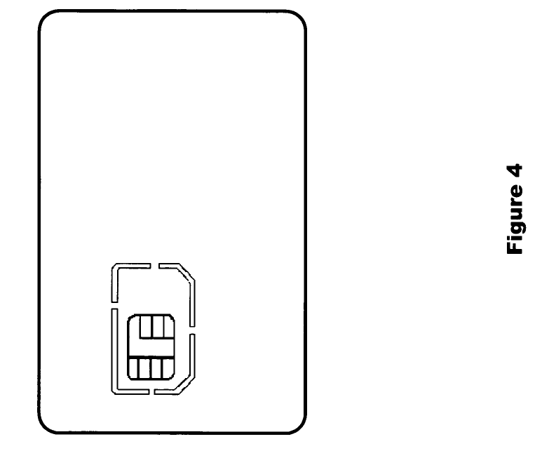

As shown in FIGS. 4-5, the present invention may be embodied as either a SIM card (FIG. 4) or as a full-ISO sized card (FIG. 5). When utilized in connection with a full-ISO sized card, the full-ISO sized card serves as a carrier for the plug-in sized SIM card.

The present invention offers distinct advantages over the prior art by providing a plurality of data formats on a single card. The integrated electronic module 110 is individually readable and/or may be activated by the electronic device when the card is inserted into the electronic device with the integrated electronic module 110 contacting the IC interface in the electronic device. Any number of various data formats may then be selected from storage 112 for use with integrated electronic module 110.

In an alternative embodiment where multiple integrated electronic modules chips 114, 114′, 114″ are utilized, the remaining modules are not connected to the electronic device, but rather are safely stored inside the device without any inconvenience or risk of loss or misplacement, which eliminates the need to carry or store a plurality of different integrated electronic cards.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. An integrated circuit card insertable into an electronic device to facilitate communication with a network, the integrated circuit card comprising:
a card, keyed for insertion into the electronic device such that the card may only be inserted in a particular orientation;
at least one integrated electronic module mounted to said card;
a storage located on said card and assessable by said at least one integrated electronic module, said storage including a plurality of data formats, each data format corresponding to a different network for the electronic device to communicate with;
a selector, for selecting one of the plurality of data formats;
said at least one integrated electronic module enabling the electronic device to perform an electronic device application when said at least one integrated electronic module is configured with a selected data format compatible with the network.

2. The integrated circuit card according to claim 1, wherein the at least one integrated electronic module and the storage are provided as one semiconductor chip.

3. The integrated circuit card according to claim 1, wherein the integrated circuit card is selected from the group consisting of a SIM card, a MultiMedia card, a secure digital memory card, a flash memory card, and a solid-state memory card.

4. The integrated circuit card according to claim 3, wherein the integrated circuit card is a subscriber identity module card.

5. The integrated circuit card according to claim 4, wherein the integrated circuit card is a plug-in sized subscriber identity module card.

6. The integrated circuit card according to claim 1, wherein said selector comprises a visual display and interface such that a user may select one of the plurality of data formats.

7. The integrated circuit card according to claim 6, wherein the plurality of data formats is displayed on the visual display in the form of a list.

8. The integrated circuit card according to claim 1, wherein the plurality of data formats stored on said storage may be updated.

9. The integrated circuit card according to claim 1, wherein additional data formats may be added to and stored on said storage.

10. A method of providing a data format for an integrated circuit module located on a SIM card for use with a mobile phone to facilitate communication of the mobile phone with a local network comprising the steps of:
locating at least one integrated electronic module on the SIM card;
providing a storage accessible by the integrated electronic module;
storing a plurality of data formats on the storage, each data format corresponding to a different network;
accessing the plurality of data formats saved on the storage;
selecting one of the plurality of data formats;
performing an electronic device application when the at least one integrated electronic module is configured with the selected data format that is compatible with the network.
